(19) United States
(12) Patent Application Publication
(10) Pub. No.: US 2003/0065746 A1
(43) Pub. Date: Apr. 3, 2003

(54) Omni-marketingSM system

(76) Inventors: Thomas Nello Giaccherini, Carmel Valley, CA (US); James Riley Stuart, Louisville, CO (US)

Correspondence Address: Giaccherini, Post Office Box 1146, Carmel Valley, CA, 93924, US

(21) Appl. No.: 10/112,826

(22) Filed: Apr. 1, 2002

(30) Foreign Application Priority Data
May 23, 2001 PCT/US01/14828

(51) Int. Cl. G06F 15/16

(52) U.S. Cl. 709/219

(57) ABSTRACT

Methods and apparatus for gradually delivering information over a network to a customer are disclosed. The information is delivered over a high-speed or low-speed connection to an extremely large storage device located at the customer's premises. A vendor may supply virtually or substantially all of his content to the customer's storage device. The customer then retrieves, uses, displays or enjoys relatively small selections of content instantly, on-demand, without ordering the content or waiting for a download.

### BACKGROUND OF THE INVENTION

Many forms of information are distributed in hard copy. Billions of software programs, video games, musical selections, newspapers, magazines, telephone directories, catalogs, educational materials, manuals and other compilations of information are printed or recorded on a physical media and then delivered to customers every year.

None of these forms of physical works provides a convenient and automatic means of supplying information to customers without incurring the enormous expense of printing and shipping a recorded or printed product. The development of such a system would constitute a major technological advance, and would satisfy long felt needs and aspirations in the publishing industry.

### SUMMARY OF THE INVENTION

The present invention, the OmniMarketing^{SM}System, provides a novel method and apparatus for providing digital content to customers. The invention enables content providers to essentially deliver all their products and/or services using point-to-multi-point or point-to-point connections to all their customers. In general, the invention makes it possible for a content vendor to place substantially all of their content in a cache located on the customer's premises. This “extreme-edge cache” allows the customer to use, test, view or enjoy content immediately. As an example, a software company like Microsoft® will be able to supply substantially all of their software to all of their customers wirelessly and automatically in exchange for a periodic subscription fee. A movie studio like Warner Brothers® or Sony/Columbia® will be able to furnish substantially all of their motion pictures to a customer's residence. A publisher such as Knight-Ridder® will be able to use the present invention to distribute substantially all of the text and graphical content of their newspapers and magazines to readers around the world. Universal-Vivendi® will be able to offer all the recorded music which they own.

One embodiment of the invention comprises a stand-alone, wireless, automatic device that is capable of operating without a personal computer. The content is delivered over a network to subscribers. The content may be delivered gradually, or may be dispatched in real-time over a high-speed connection. In alternative embodiments, the invention may incorporate a personal computer, a printer, or a video or audio receiver.

The invention also provides a highly secure distribution system which thwarts copyright infringement and other unauthorized copying. The system may also be tamper-proofed, so that any attempt to make unauthorized copies of the information, or to open the receiver cause an immediate erasure of all the programs stored in the receiver.

In one preferred embodiment of the invention, a peripheral device called the “OmniVault™” is connected to the customer's personal computer. This device connects to a computer using a USB or other port, and includes an FM radio or television receiver chip, a large storage device, and a security chip. In one embodiment, the storage device is capable of holding Gigabytes or Terabytes of content. In another embodiment of the invention, the OmniVault™ may be built into the customer's personal computer.

An appreciation of the other aims and objectives of the present invention and a more complete and comprehensive understanding of this invention maybe obtained by studying the following description of a preferred embodiment, and by referring to the accompanying drawings.

### A BRIEF DESCRIPTION OF THE DRAWINGS

FIGS. 1A and 1B are illustrations which show the transfer of data to customers using a variety of networks.

FIG. 2 is a generalized pictorial description of the Omni-Marketing^{SM} System.

### A DETAILED DESCRIPTION OF PREFERRED & ALTERNATIVE EMBODIMENTS

I. Overview of the Invention

The present invention comprises methods and apparatus for delivering information to customer over a network. The information may be delivered to the customer over any connection, whether high-speed or low-speed. In one embodiment, data may be delivered to subscriber's by direct transmissions from AM broadcast, FM broadcast, terrestrial VHF and UHF television stations or satellite systems. In this Specification and in the Claims that follow, the term “information” encompasses any form of code, data, text, graphics, images, music, video, audio, message, or other manifestation of intelligence, knowledge, pattern or expression.

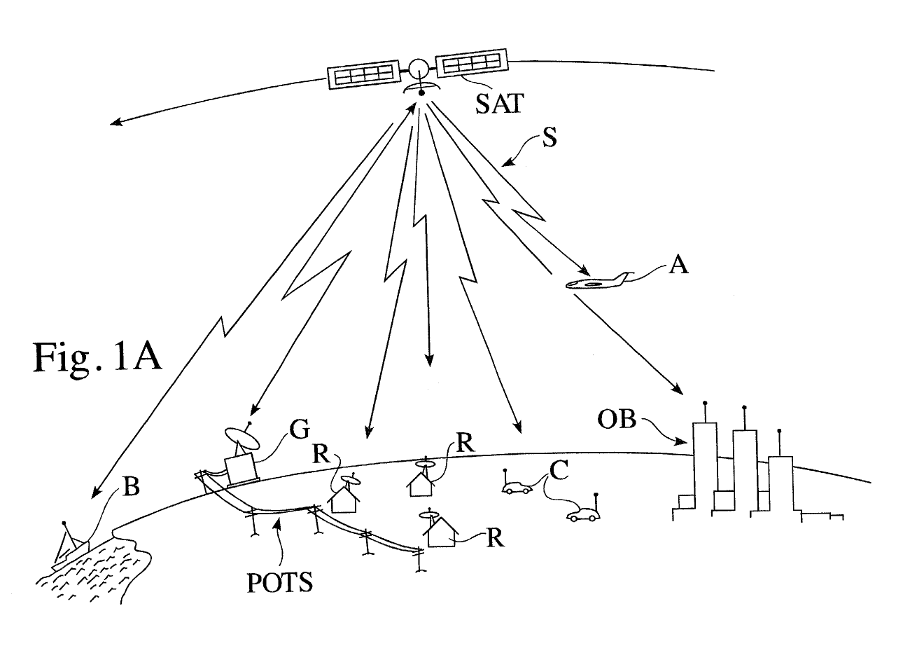

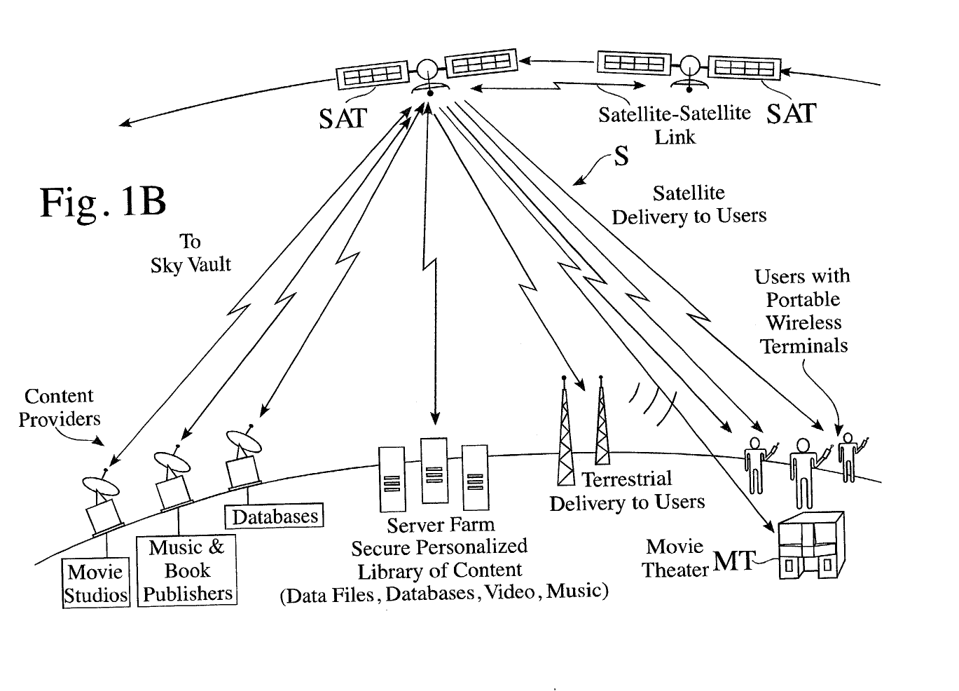

FIGS. 1A & 1B generally illustrate the embodiments of the present invention which employ satellites SAT. A satellite SAT in Earth orbit is capable of communicating with a ground station G. The ground station G is connected to a terrestrial network, such as a public switched telephone network POTS. The satellite SAT is capable of delivering packets of data to many different types of terminals, including residences R, office buildings OB, cars and other vehicles C, aircraft A and boats B. In another embodiment, the invention may be utilized to transmit signals S to a wide variety of terminals, including cellular phones, personal digital assistants, portable computers and displays, or other intelligent appliances. In these embodiments, digitized, heavily-encrypted packets are beamed up to the satellite SAT from a ground station G that stores an electronic, digital copy of a copyrighted first-run motion picture. In one embodiment, the transfer of packets is accomplished using asynchronous transfer methods, and the packets are then routed to, and may be resequenced in order at their final destination.

Another alternative delivery method is a direct, high-speed connection, using either the Internet or telephone or cable lines.

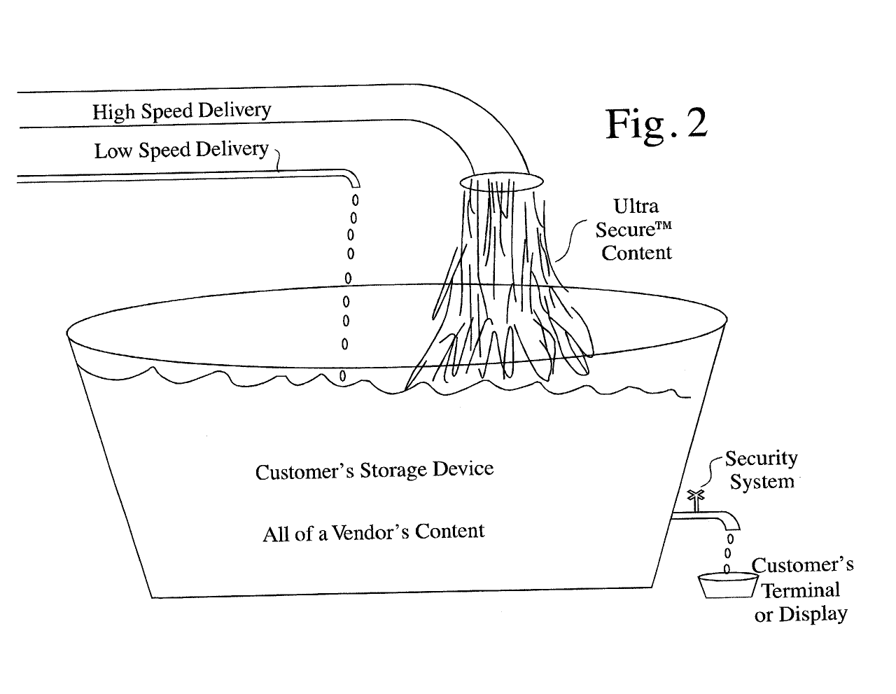

FIG. 2 offers a pictorial view of the alternative delivery methods. The customer's storage device may be filled by either a high-speed or a low-speed connection. In general, the vendor may “edge-cache” a very large portion or substantially all of its content to the customer's storage device. In general, the customer only uses a small portion of the content at any given time. The customer may use or enjoy the content on-demand without specifically ordering the content or waiting for a download from the vendor.

In the preferred embodiment, the invention utilizes a very large storage device at the customer's premises. In one embodiment the storage device is an array of hard drives having a capacity of several hundred or several Terabytes of data. This very large capacity storage device enables a vendor to supply virtually all of its product to the storage device at the customer's premises. The customer may test, try, sample, use or display the content stored on his or her storage device. The customer's use of any of the content present in the storage device may be regulated by a security system which authenticates the customer's account with a particular vendor. In general, a customer uses or consumes only a very small portion of the content present on his or her storage device.

In the various alternative embodiments, the information delivered to the customer may include software programs, movies, television programs, games, Internet content, educational materials, music selections, directories, manuals, newspapers, magazines, periodicals, books or any other information or compilation.

### Conclusion

Although the present invention has been described in detail with reference to one or more preferred embodiments, persons possessing ordinary skill in the art to which this invention pertains will appreciate that various modifications and enhancements maybe made without departing from the spirit and scope of the Claims that follow. The various alternatives for providing a highly secure data distribution system that have been disclosed above are intended to educate the reader about preferred embodiments of the invention, and are not intended to constrain the limits of the invention or the scope of Claims.

What is claimed is:

1. A method comprising the steps of:
conveying information over a network to a customer;
accumulating said information in a storage device automatically; and
retrieving said information for on-demand use at a time after said information is accumulated.

2. A method of offering digital content comprising the steps of:
supplying a customer with substantially all of a vendor's content; and
enabling said customer to select and use substantially of all said vendor's content stored at the customer's premises.

3. A method as recited in claim 2, in which said vendor's content is a software program.

4. A method as recited in claim 2, in which said vendor's content is a movie.

5. A method as recited in claim 2, in which said vendor's content is a selection of recorded music.

6. A method as recited in claim 2, in which said vendor's content is a newspaper.

7. A method as recited in claim 2, in which said vendor's content is a magazine.

8. A method as recited in claim 2, in which said vendor's content is a selection of distance learning materials.

9. A method as recited in claim 2, in which said vendor's content is a video game.

10. A method of offering digital content comprising the steps of:
transmitting substantially all of a vendor's content to a customer;
storing said vendor's content on a storage device; said storage device being located at said customer's premises; and
permitting said customer to select and instantly initiate use of a relatively small segment of all of said vendor's content.

11. A method as recited in claim 10, which is transmitted in real-time over a high-speed connection.

12. A method as recited in claim 10, which is transmitted gradually over a low-speed connection.
